(19) United States
(12) Patent Application Publication
(10) Pub. No.: US 2008/0168545 A1
(43) Pub. Date: Jul. 10, 2008

(54) Method for Performing Domain Logons to a Secure Computer Network

(76) Inventors: Tadanobu Inoue, Yokohama-shi (JP); Seiichi Kawano, Sagamihara-shi (JP); David C. Challener, Raleigh, NC (US); Philip L. Childs, Raleigh, NC (US)

Correspondence Address: DILLION & YUDELL LLP, 8911 N. CAPITAL OF TEXAS HWY, SUITE 2110, AUSTIN, TX, 78759, US

(21) Appl. No.: 11/621,288

(22) Filed: Jan. 9, 2007

(51) Int. Cl. H04L 9/32; G06F 13/00

(52) U.S. Cl. 726/6; 711/163; 711/E12.002

(57) ABSTRACT

A method for performing a domain logon to a computer network is disclosed. A secure storage area containing user identification information and domain password information corresponding to the user identification information is provided. In response to a receipt of a user-entered user identification and a user-entered domain password by a first module of a Windows® operating system, the domain password information stored in the secure storage area and the corresponding user identification information are written to a registry of the Windows® operating system. Authentication for domain logon is then performed by a second module of the Windows® operating system based on the received domain password and the domain password information written to the registry of the Windows® operating system. After the authentication, the domain password information is subsequently removed by the first module of the Windows® operating system from the registry of the Windows® operating system.

### BACKGROUND OF THE INVENTION

1. Technical Field

The present invention relates to computer networks in general, and, in particular, to a method for authenticating a user on a computer within a network environment. Still more particularly, the present invention relates to a method and apparatus for enhancing security of domain authentications without modifying basic modules of a Windows® operating system.

2. Description of Related Art

In personal computers (PCs), multiuser-capable operating systems (OSs) such as Windows® NT/2000/XP manufactured by the Microsoft Corporation are commonly used. After a PC has been powered on and devices have been initialized by the Basic Input/Output System (BIOS), the OS is started. A user then logs on to the OS by entering authentication information, such as, a user identification (user ID) and an authentication password. The process of logging on to a PC by entering a user ID and a password registered with the PC is called local logon.

Multiple PCs operating with OSs of the Windows® series may be connected with each other via Ethernet so that a local-area network (LAN) or a wide-area network (WAN) may be readily built. In such a case, computer resources such as PCs and printers logically treated as one group are collectively called a domain. Within a domain, user IDs and security policies are basically managed by one computer known as a domain controller. A domain controller can centrally perform processing such as user authentication, addition and deletion of user's, accounts, and modification of security settings. There may be more than one domain controller within a domain. In such a case, a domain controller mainly used as a primary domain controller, and others may be backup domain controllers for backup. Domains as used herein may be NT domains or Active Directory domains, depending on the version of Windows® or the scale of the LAN or WAN, but they will be collectively referred to as domains.

On a computer participating in a domain, logon may also be performed by entering a user ID and a password registered with the domain controller of that domain instead of performing a local logon, and such process is called domain logon. While a local logon is performed on a PC with which a user ID and a password are registered, a domain logon can be performed on all PCs participating in the domain by using user IDs and passwords registered with the domain controller. A domain logon allows the usage of computer resources shared in that domain. Furthermore, a domain logon allows the usage of computer resources of other domains that are in a trust relationship with that domain.

Referring now to the drawings and in particular to FIG. 13, there is illustrated a conceptual view showing the mechanism of logon on a PC belonging to a domain, according to the prior art. When Windows® is being started, three desktop screens are created, namely, an application desktop 1001 to be displayed during regular operations in Windows®, a screen saver desktop 1003 for displaying a screen saver, and a WinLogon desktop 1005 for displaying a logon screen. Only one of these desktop screens are usually displayed on a display unit. WinLogon 1007 is a component that performs processing in Windows® such as management of logon sessions and switching among the desktop screens displayed on the display unit.

The screen prompting for a user ID and a password, displayed upon startup of Windows®, is the WinLogon desktop 1005. A component called Graphical Identification and Authentication (GINA) 1009 of Windows® displays a dialog for entering a user ID and a password. A user enters a user ID, a password, and a logon target on the dialog 1011 displayed by the GINA. The entered user ID and password are passed to a component called Local Security Authority (LSA) 1013 through GINA 1009. LSA 1013 functions as an agent for processing user logon and authentication. The logon target may be selected between the PC itself and the domain to which the PC belongs. Selecting the PC itself as the logon target leads to the local logon, and selecting the domain leads to the domain logon.

LSA 1013 passes the user-entered user ID, password, and logon target to Authentication Package (AP) 1015. AP 1015 authenticates the user according to the logon target specified by the user. For a local logon, AP 1015 compares the password received from LSA 1013 with a password retrieved from a user account database 1019 maintained by a component called Security Accounts Manager (SAM) 1017 of Windows®. AP 1015 then verifies whether the user, who has entered the user ID and the password, is an authenticated user.

For a domain logon, AP 1015 accesses a domain controller 1021 of the domain to which the PC belongs and queries domain controller 1021 for the user ID and the password received from LSA 1013. Mutual authentication is performed between the PC and domain controller 1021 with a technique such as LM authentication, NTLM authentication, or NTLMv2 authentication. During authentication, domain controller 1021 receives a request containing the user ID from the PC and returns a character string called a challenge to the PC. The PC receives the challenge and returns to domain controller 1021 a character string (a response) obtained by encrypting the challenge with the password. Domain controller 1021 verifies from the response whether the user ID and the password are authenticated, and returns the verification result to the PC. This technique allows authentication by querying domain controller 1021 for the authenticity of the user ID and the password without directly transmitting the password over the network.

In either of the local logon and the domain logon, once the authentication succeeds, WinLogon 1007 switches the desktop screen displayed on the display unit to application desktop 1001. The above-described user authentication mechanism is defined as a standard specification of Windows®. Furthermore, a mechanism for customizing the user authentication is open to software developers. If a third party needs to customize the user authentication of Windows®, they typically generate the GINA of their own and register the GINA as a Windows® component. Generating a unique GINA and passing the user ID and the password from the GINA to the LSA can realize customized unique user authentication without modification of other components involved in user authentication. Although a technique of generating a unique AP for providing the user authentication mechanism by a third party is also open to software developers, this technique is rarely used in actual products because more effort is required compared to the generation of the GINA.

Under the Windows® operation environment, logon information on a user who has succeeded in the domain logon is saved in a location called a cache 1025 in a registry 1023 of the PC. The logon information as used herein includes the user ID, the password, the date and time of the logon, the domain name, and the host name of the PC. If the PC cannot connect to domain controller 1021, the logon information saved in cache 1025 may be used to log on with the same user ID and password as would be used if the PC could connect to domain controller 1021. For example, if a notebook PC usually connected to a LAN and belonging to a domain in an office is disconnected from the LAN and used outside the office, the notebook PC cannot connect to domain controller 1021 in the office. As another example, a PC connected to a wireless LAN may become unable to connect to domain controller 1021 due to a deteriorated radio wave condition of the wireless LAN. Even in such cases, the domain logon may be performed with the logon information saved in cache 1025, and the account registered with domain controller 1021 may be used to log on to the notebook PC. Then, the same operation environment as in the case where a connection can be made to domain controller 1021, for example the arrangement of the desktop screen, the configuration of the start menu, or software settings, may be reproduced and used. The logon information is saved in cache 1025 for a predetermined number of past successful domain logons of each user. The number of times of saving may be variably set in the range of 0 to 50 times. By default, the logon information for past ten successful domain logons is saved.

However, the logon information saved in cache 1025 may be obtained by anyone who is given an operation authority above a certain degree. For the domain logon, the registered user ID and password may be used to perform logon on all PCs participating in the domain as described above, so that the PC concerned is likely to have been used by multiple users belonging to the domain. Therefore, any user who is given the authority to access cache 1025 may obtain the logon information on all users who have recently performed the domain logon on the PC. That is, if a malicious user logs on, there is a risk of user ID and password theft because such user can access another user's user ID and hashed password. Furthermore, even if the password saved in cache 1025 is sorted and hashed, the password in the unhashed form can be found with a technique such as the dictionary attack. Tools for finding passwords with the dictionary attack (password cracking tools) and dictionaries sorted in the order of frequency of use to be used with those tools are readily available to anyone via the Internet.

The logon information is saved in cache 1025 within registry 1023 while Windows® is operating. However, the logon information is saved in a system file 1027 in a magnetic disk device upon logoff of Windows®, so that the logon information may be used again in the next logon as information saved in the cache within the registry. Furthermore, the file name by which the logon information is saved, the address in the magnetic disk, and even the data structure in the file and the algorithm of a hash function are open to software developers. Therefore, the logon information saved in cache 1025 may be copied from system file 1027 by installing another OS (such as Linux) in the PC, starting another OS from a disk such as a floppy disk, an optical disk, or by other means. The unencrypted user ID and the hashed password may be read out from this file as well. In particular, if the PC itself or the magnetic disk device removed from the PC is stolen, such means may be used to read out user IDs and passwords of multiple users belonging to the domain.

As described above, the number of times the logon information is saved in cache 1025 may be variably set in the range of 0 to 50 times for the past successful domain logons. More specifically, the value stored as CachedLogonsCount of HKEY_LOCAL_MACHINE\Software\Microsoft\WindowsNT\Current Version\Winlogon of registry keys indicates the number of times the logon information is saved for the past successful domain logons. Setting this value to “0” results in no logon information saved in cache 1025, thereby reducing the risk of theft of the passwords included in the logon information. However, the domain logon utilizing cache 1025 would then be impossible, and the local logon would be the only way to log on to the notebook PC in environments where a connection cannot be made to domain controller 1021. This is inconvenient because of the impossibility of reproduction of the operation environment that would be provided if the domain logon were possible.

Consequently, it would be desirable to provide a method for performing domain logon and storing a domain password in a more secure manner while maintaining the convenience of the domain logon available in Windows® without modifying basic modules of Windows® or providing special hardware. It would also be desirable to provide a method for performing the domain logon and storing the domain password information with a reduced risk of a malicious user obtaining logon information through information stored in a cache while allowing the domain logon utilizing the cache within a registry.

### SUMMARY OF THE INVENTION

In accordance with a preferred embodiment of the present invention, a secure storage area containing user identification information and domain password information corresponding to the user identification information is provided. In response to a receipt of a user-entered user identification and a user-entered domain password by a first module of a Windows® operating system, the domain password information stored in the secure storage area and the corresponding user identification information are written to a registry of the Windows® operating system. Authentication for domain logon is then performed by a second module of the Windows® operating system based on the received domain password and the domain password information written to the registry of the Windows® operating system. After the authentication, the domain password information is subsequently removed by the first module of the Windows® operating system from the registry of the Windows® operating system.

All features and advantages of the present invention will become apparent in the following detailed written description.

### BRIEF DESCRIPTION OF THE DRAWINGS

The invention itself, as well as a preferred mode of use, further objects, and advantages thereof, will best be understood by reference to the following detailed description of an illustrative embodiment when read in conjunction with the accompanying drawings, wherein:

FIG. 1 is a block diagram of a personal computer, according to a first embodiment of the present invention;

FIG. 2 is a block diagram of a Trusted Platform Module;

FIG. 3 is a conceptual view of a TCG Software Stack;

FIG. 4 is a conceptual view of a user logon mechanisem, in accordance with a first embodiment of the present invention;

FIGS. 5-6 are flowcharts showing a user logon process, in accordance with a first embodiment of the present invention;

FIG. 7 is a block diagram of a personal computer, according to a second embodiment of the present invention;

FIG. 8 is a diagram of BIOS flash ROM, NVRAM, and main memory in accordance with a second embodiment of the present invention;

FIG. 9 is a conceptual view of a user logon mechanisem, in accordance with a second embodiment of the present invention;

FIGS. 10-11 are flowcharts showing a user logon process, in accordance with a second embodiment of the present invention;

FIG. 12 is a conceptual view showing the timing with which logon information is written to and erased from a registry in domain logon; and

FIG. 13 is a conceptual view showing the mechanism of conventional logon on a personal computer belonging to a domain.

### DETAILED DESCRIPTION OF A PREFERRED EMBODIMENT

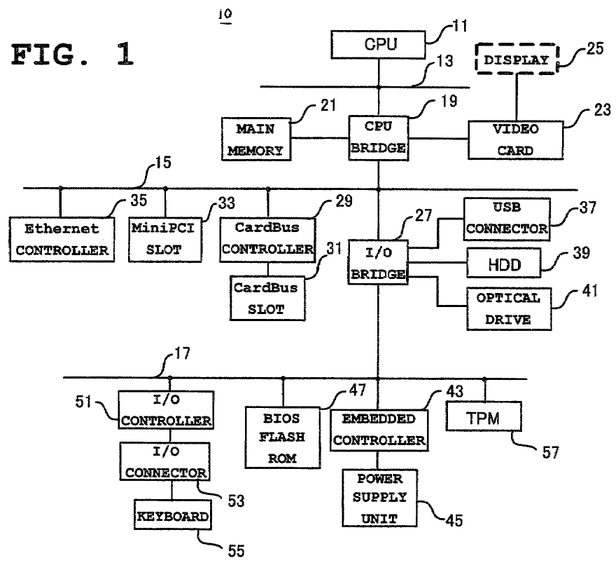

FIG. 1 is a block diagram of a personal computer (PC) 10, functioning as a client computer, according to a first embodiment of the present invention. Various devices shown in FIG. 1 are provided inside the cabinet of PC 10. A CPU 11 is a processing unit responsible for the central functionality of PC 10 and executes an OS, BIOS, device drivers, application programs, and so forth. The present embodiment is applicable to any of Windows® NT, 2000, and XP but not to Windows® 98 or earlier versions. CPU 11 can operate in a System Management Mode (SMM), which is an operating mode for system management when a System Management Interrupt (SMI) input pin (SMI#) is asserted. In SMM, an SMI handler, which is an interrupt control handler residing in CPUs manufactured by the Intel Corporation, is executed in a specially allocated memory space. SMM is a privileged execution mode mainly used for suspend, resume, power management, security-related operations, and the like.

CPU 11 sends and receives signals while being connected to devices via three stages of buses, namely, a Front Side Bus (FSB) 13 as a system bus, a Peripheral Component Interconnect (PCI) bus 15 for communication between CPU 11 and peripheral devices, and a Low Pin Count (LPC) bus 17, which is an interface taking the place of an ISA bus. FSB 13 and PCI bus 15 are connected with each other via a CPU bridge 19 called a memory/PCI chip. CPU bridge 19 has functions such as a memory controller function for controlling access operations to a main memory 21 and a data buffer function for absorbing the difference of the data rate between FSB 13 and PCI bus 15. Main memory 21 is writable memory used as an area into which programs executed by CPU 11 are read, and as a working area to which processing data is written. Main memory 21 also includes an area as System Management RAM (SMRAM) usable exclusively by CPU 11 operating in SMM. A video card 23 has a video chip (not shown) and VRAM (not shown). In response to a rendering instruction from CPU 11, video card 23 generates a rendering image and writes it to the VRAM, and sends the image read out from the VRAM to a display 25 as rendering data.

An I/O bridge 27, a CardBus controller 29, a miniPCI slot 33, and an Ethernet controller 35 are connected to PCI bus 15. CardBus controller 29 is a controller for controlling data transfer between PCI bus 15 and a PC card (not shown). Connected to CardBus controller 29 is a CardBus slot 31, into which a PC card (not shown) is inserted. Inserted into miniPCI slot 33 is, for example, a miniPCI card with an internal wireless LAN module (not shown). Ethernet controller 35 is a controller for connecting PC 10 to a wired LAN.

I/O bridge 27 has a function as a bridge between PCI bus 15 and LPC bus 17. I/O bridge 27 also has an Integrated Device Electronics (IDE) interface function, so that a hard disk device (HDD) 39 and an optical drive 41 (such as a CD drive or a DVD drive) are connected thereto. Also connected to I/O bridge 27 is a USB connector 37, to which various USB-capable peripheral devices (not shown) are connected. An embedded controller 43, a BIOS flash ROM 47, a Trusted Platform Module (TPM) 57, and an I/O controller 51 are connected to LPC bus 17. Input/output devices (not shown) including a keyboard 55 are connected to I/O controller 51 via an I/O connector 53. BIOS flash ROM 47 and the Trusted Platform Module (TPM) 57 will be described later.

Embedded controller 43 is a microcomputer including an 8-bit to 16-bit CPU, ROM, and RAM, and further includes a multi-channel A/D input terminal, D/A output terminal, and digital I/O terminal. A cooling fan (not shown), a thermal sensor (not shown), a power supply unit 45, and so forth are connected to embedded controller 43 via these I/O terminals, so that programs for managing the operation environment inside the PC may be run independently from CPU 11.

FIG. 1 only describes the configuration and connections of the main hardware related to the present embodiment in a simplified form for illustrative purposes. Besides those mentioned in the above description, many devices are used to configure PC 10. However, those devices are well known to those skilled in the art and therefore will not be described in detail here. Of course, several blocks shown may be implemented as one integrated circuit or one device, or conversely, one block may be divided into several integrated circuits or devices. Such implementations also fall within the scope of the present invention to the extent of arbitrary choice of those skilled in the art.

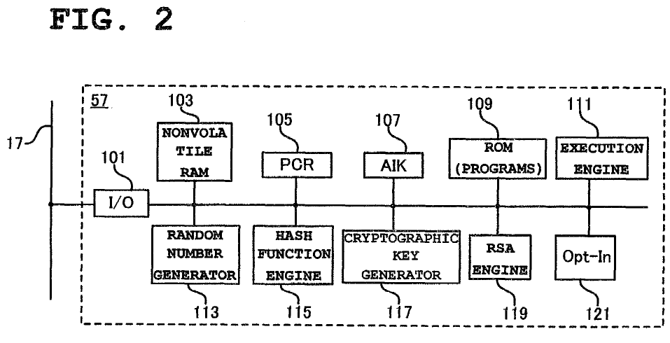

FIG. 2 is a block diagram of TPM 57 for enhancing security of PC 10. TPM 57 is manufactured based on a specification developed by Trusted Computing Group (TCG), and provided in PC 10 of FIG. 1. TPM 57 exchanges data with LPC bus 17 via I/O 101. Keys used for authenticating platforms and users are stored in a nonvolatile RAM 103. In the present embodiment, a cache database to be described later is also stored in nonvolatile RAM 103. A Platform Configuration Register (PCR) 105 is a register for maintaining platform state information (software measurements). An Attestation Identity Key (AIK) 107 is used in platform authentication for adding a digital signature to data inside TPM 57.

Various programs used for authentication of platforms and users are stored in a ROM 109 and executed in an execution engine 111 including a processor and volatile RAM. In the present embodiment, a logon information management program to be described later is also stored in ROM 109. TPM 57 also includes: a random number generator 113 for generating random numbers; a hash function engine 115 for executing a cryptographic hash function, which is a one-way function used for encryption; an RSA engine 119 for adding an electronic signature to a cryptographic key generated by a cryptographic key generator 117; and an Opt-In 121 for preventing PC 10 to be used at unintended places. The content stored in nonvolatile RAM 103 can be referred to only by execution engine 111 and cannot be directly accessed by CPU 11.

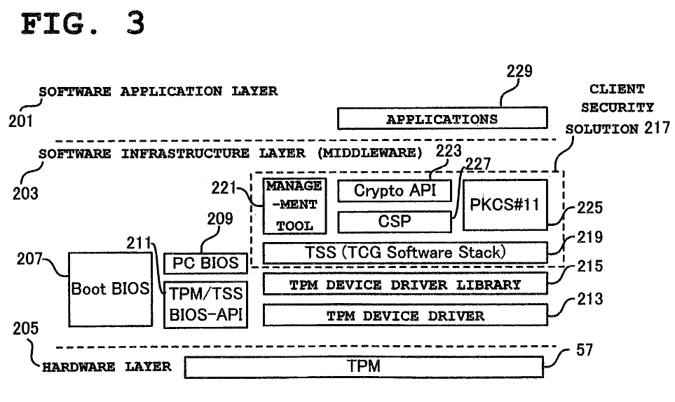

TCG Software Stack (TSS) is defined by TCG as a software stack for allowing application software to use TPM 57. FIG. 3 is a conceptual view of a TSS. TPM 57 is associated with PC 10 as hardware and constructs a reliable platform in PC 10, while application software may use functions of TPM 57 through a driver. Three layers are defined in the TSS, namely, a software application layer 201, a software infrastructure (middleware) layer 203, and a hardware layer 205. Belonging to hardware layer 205, TPM 57 is directly operated by a Boot BIOS 207, which is stored in BIOS flash ROM 47 and started first upon power-on of PC 10. TPM 57 is also operated through a TPM/TSS BIOS API 211 by a PC BIOS 209, which is stored in BIOS flash ROM 47 and performs system configuration.

For Windows®, a device driver 213 conforming to TPM 57 and a library 215 for using device driver 213 are provided in software infrastructure layer 203. Also provided is a client security solution 217, which is an application that runs on device driver 213 and library 215 and provides functions such as user authentication, encryption, protection of electronic certificates to general application software 229 such as Internet Explorer and Outlook. Client security solution 217 includes: a TSS 219, which is a standard software stack; a management tool 221 for performing processing such as setting of the TPM; and a Crypto API 223 of Microsoft Corporation, a PKCS #11 225 of RSA Security Inc., and other Crypto Service Provider (CSP) 227, which are standard APIs for cryptography. Application software 229 can use these APIs to pass processing related to user authentication and encryption to TPM 57 and cause TPM 57 to perform processing. Of course, since the processing is performed when the platform and the user are properly authenticated, starting an OS different from Windows® intended to operate on PC 10 would result in failure of performing the processing.

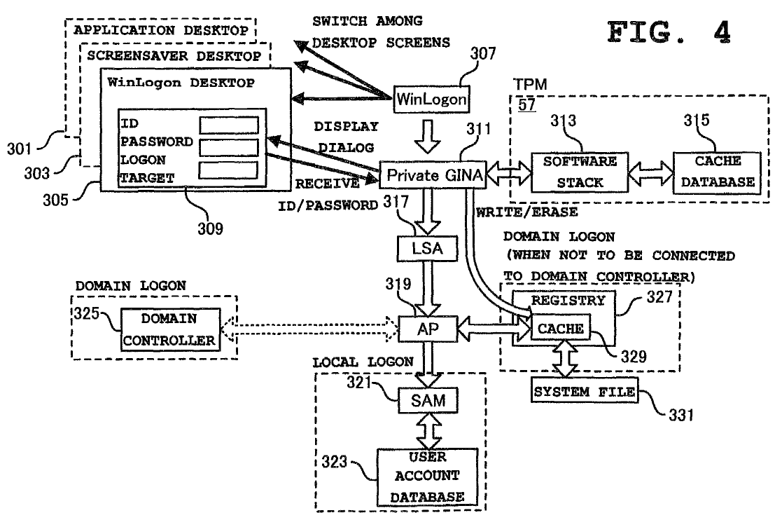

FIG. 4 is a conceptual view showing a user logon mechanism, in accordance with a first embodiment of the present invention. It is assumed that PC 10, a client, is configured to comprise a network environment as a member of a domain along with a domain controller. Authentication information on multiple users permitted by an administrator to participate in the domain is registered with the domain controller. Upon power-on of PC 10, Boot BIOS 207 and PC BIOS 209 stored in BIOS flash ROM 47 are first read out to CPU 11 and executed, and a self test and initial configuration of the hardware in PC 10 are performed. Subsequently, Windows® installed on HDD 39 is read out to CPU 11 and executed. When Windows® is started, three desktop screens are created, namely, an application desktop 301 to be displayed during regular operations in Windows®, a screen saver desktop 303 for displaying a screen saver, and a WinLogon desktop 305 for displaying a logon screen. A WinLogon 307 displays WinLogon desktop 305 among them on display 25.

On WinLogon desktop 305, a private GINA 311 displays a dialog 309 for entering a user ID, a password, and a logon target. Since PC 10 is registered in advance by the network administrator as a member of the domain, dialog 309 is displayed such that a user can select between the local logon and the domain logon. Private GINA 311 is a GINA customized for the present embodiment and registered as a component of Windows®. When the user enters a user ID and a password for either the local logon or the domain logon on dialog 309 through keyboard 55, the entered user ID is passed from private GINA 311 to execution engine 111 in TPM 57 via TSS 219 and device driver 213 included in software stack 313. A cache database 315 resides on nonvolatile RAM 103 and saves logon information on the past successful domain logons. The logon information includes information obtained by sorting and hashing passwords entered by users to PC 10. In execution engine 111, the logon information management program that is read out from ROM 109 is used to perform processing to be described later. Programs other than private GINA 311 cannot access the logon information management program. In addition, programs other than the logon information management program cannot refer to the content of cache database 315.

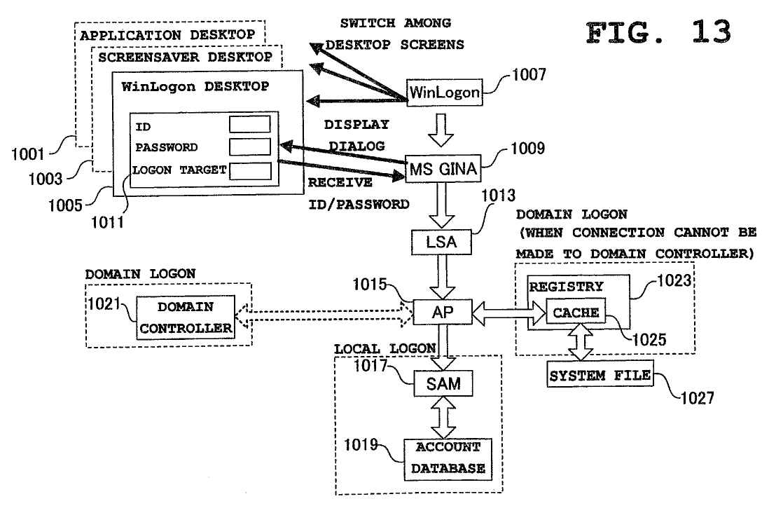

All of an LSA 317, an AP 319, a SAM 321, a user account database 323, a domain controller 325, a registry 327, a cache 329, and a system file 331 are the same as those devices shown in FIG. 13 and therefore will not be described. However, the present embodiment enhances security by not saving the logon information on any user in cache 329 when Windows® is started to initiate user authentication. At the time of user authentication, only the logon information required for authenticating a user who is attempting the logon is written by private GINA 311 to cache 329. In Windows®, performing a domain logon when a connection cannot be made to a domain controller requires the presence of the logon information on the user concerned in cache 329. Therefore, in the present embodiment, only the logon information for the user who has initiated the logon is written to cache 329 before AP 319 performs the authentication.

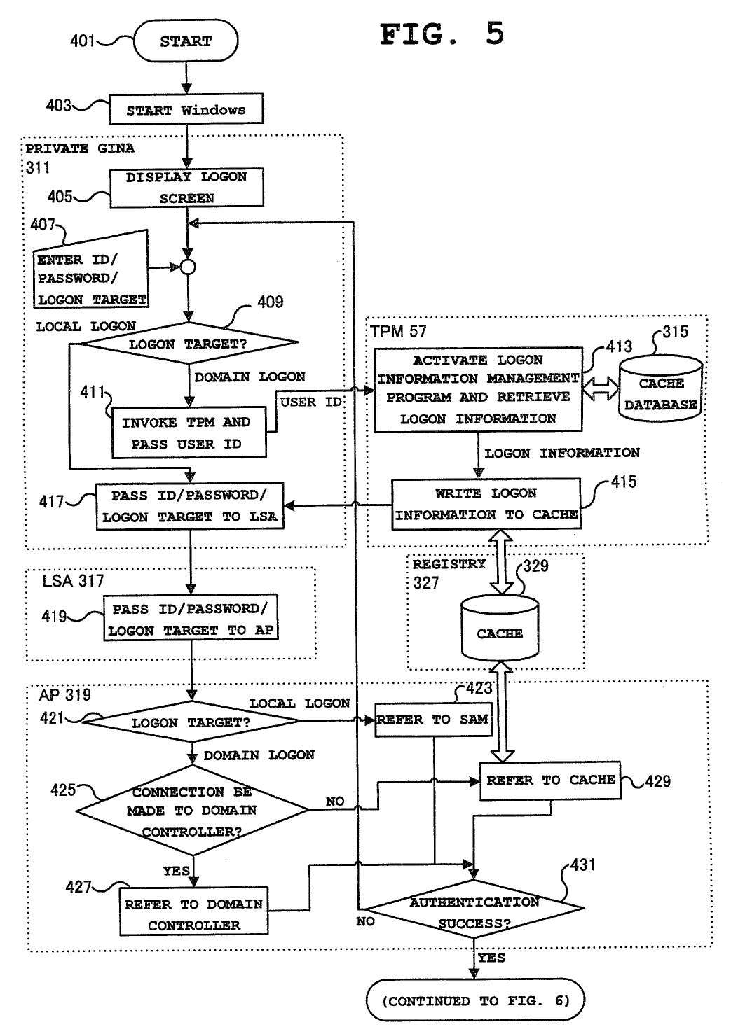

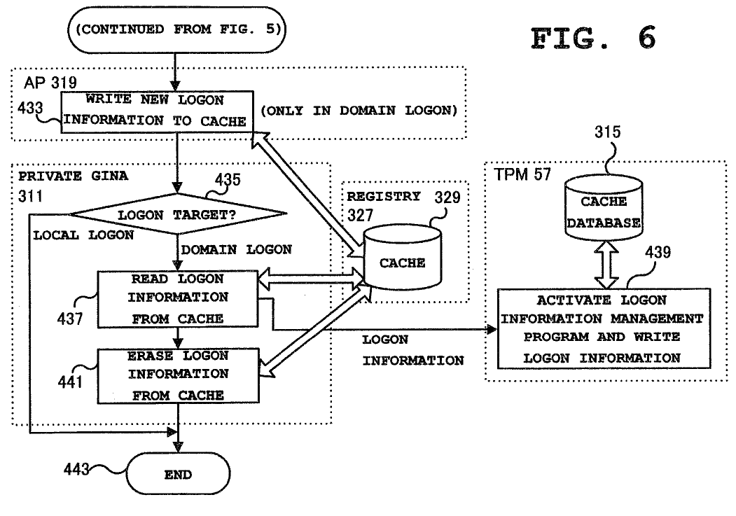

FIGS. 5 and 6 are flowcharts showing a user logon process, in accordance with a first embodiment of the present invention. The user logon includes a local logon that does not involve participating in the domain, and a domain logon that involves a participation in the domain. When PC 10 is powered on (block 401) and Windows® is started (block 403), WinLogon 307 displays WinLogon desktop screen 305 on display 25 and private GINA 311 displays dialog 309 for entering a user ID, a password, and a logon target on the desktop screen (block 405). When a user enters a user ID, a password, and a logon target on dialog 309 (block 407), private GINA 311 first checks the logon target (block 409). If the logon is the local logon, the process skips processing in blocks 411-415 and proceeds directly to block 417.

If the logon is the domain logon in block 409, the user ID entered by the user is passed to TPM 57 (block 411). TPM 57, having received the user ID, invokes the logon information management program stored in ROM 109 in TPM 57 to execution engine 111 and retrieves logon information corresponding to the entered user ID from cache database 315 (block 413). If the logon information corresponding to the entered user ID exists in cache database 315, private GINA 311 receives the logon information and writes the information to cache 329 in registry 327 of the PC (block 415). If the logon information corresponding to the user ID does not exist in cache database 315, no information is written to cache 329.

After the above processing has been completed, private GINA 311 calls WlxLoggedOutSAS, which is one of API functions, to pass the user-entered user ID, password, and logon target to LSA 317 (block 417). The user ID, the password, and the logon target received by LSA 317 are further passed to AP 319, where user authentication processing is performed in the same manner as the conventional art (block 419). AP 319 checks the logon target (block 421). If the logon is a local logon, AP 319 refers to the user account database 323 of SAM 321 (block 423). If the logon is a domain logon, AP 319 first attempts to connect to the domain controller 325 (block 425). If a connection can be made, the AP 319 queries the domain controller whether the user-entered password is authenticated (block 427). In Windows®, if a connection cannot be made to domain controller 325 in the domain logon, cache 329 is referred to (block 429). If the logon information corresponding to the entered user ID exists in cache database 315 in TPM 57, the corresponding logon information has been written to cache 329 in blocks 413 to 415. Therefore, AP 319 can refer to this logon information in cache 329 and perform the authentication. Thus, the domain logon can be performed with the information in cache 329 even though a connection cannot be made to domain controller 325. If the logon information corresponding to the entered user ID does not exist in the cache database 315 in block 413, the domain logon is impossible unless a connection can be made to domain controller 325 because no information has been written to cache 329.

If the user authentication succeeds (block 431), AP 319 writes new logon information resulted from the success of the authentication for this domain logon to cache 329 irrespective of success or failure in connecting to domain controller 325 (block 433). The new logon information written at this point includes the user ID and the password by which this domain logon has succeeded, and the date and time of the logon. The past logon information written in block 415 can be preserved or overwritten. For a local logon, writing the logon information to cache 329 is not necessary.

Following block 433, private GINA 311 again checks the logon target (block 435). If the logon is a local logon, the process skips processing in blocks 437-441 and proceeds to block 443. If the logon is a domain logon in block 435, private GINA 311 reads the new logon information written to cache 329 (block 437) and invokes the logon information management program in TPM 57 to record the read new logon information in cache database 315 (block 439). As a result, appropriate processing will be able to be performed even if the logon information processing scheme in the TPM is updated. Private GINA 311 then erases the past logon information written in block 415 and the new logon information written in block 433 from cache 329 (block 441). Thus, the user authentication is completed (block 443). Private GINA 311 calls application desktop 301 with WlxActivateUserShell, which is one of API functions, and the user may perform regular work. If the authentication fails in block 431, the process returns to entry in block 407.

Now, even if the user currently logging on accesses registry 327 and tries to read the content of cache 329, the user cannot read the logon information because the content of cache 329 is already erased in block 441. It is impossible to access cache database 315 in TPM 57 and read the content thereof by operations of the user currently logging on. Therefore, the logon information will never be obtained through cache 329 by users who can log on to the domain, as well as a third party other than those users. Still, in the present embodiment, the domain logon is possible in exactly the same manner as in the conventional art even in environments where a connection cannot be made to domain controller 325. This is because the logon information entered by the user upon the domain logon is recorded in cache database 315, and private GINA 311 writes only the logon information on the user concerned in cache 329 for every user authentication. In addition, the present embodiment does not require modifications to the processing related to the user logon in Windows® except customizing the GINA to make it into private GINA 311.

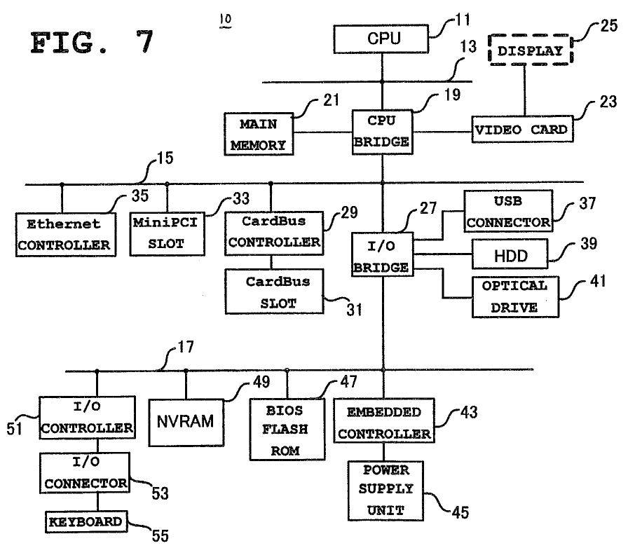

FIG. 7 is a block diagram of a PC 10′, in accordance with a second embodiment of the present invention. PC 10′ has only one difference in its configuration from PC 10 of FIG. 1. That is, PC 10′ does not include TPM 57, but PC 10′ includes an NVRAM 49 connected to LPC bus 17. NVRAM 49 is a nonvolatile RAM backed up by a battery so as not to be erased upon power-off of PC 10′. Otherwise, PC 10′ is the same as PC 10 in its configuration. Those blocks are denoted by like reference numerals and will not be described.

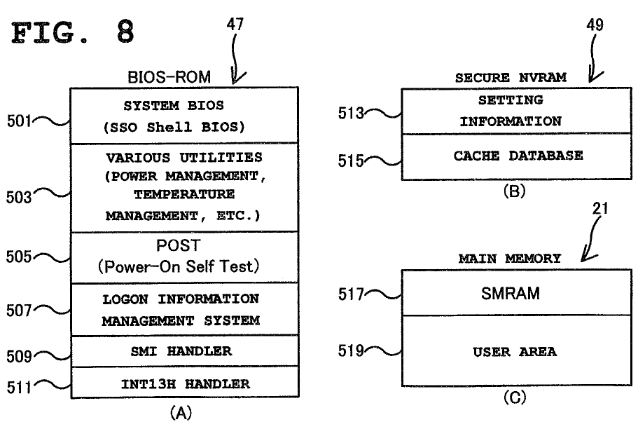

FIG. 8 is a diagram showing the internal configuration of BIOS flash ROM 47, NVRAM 49, and main memory 21 provided for the second embodiment of the present invention. BIOS flash ROM 47 shown in FIG. 8(A) is a nonvolatile memory, the memory content of which is electrically rewritable. BIOS flash ROM 47 stores the following: a system BIOS (SSO Shell Bios) 501, which is a basic program used to start and manage the system; various utilities 503, which are software for managing the operation environment including the power supply and temperature; a Power-On Self Test (POST) 505, which is software for testing the hardware upon startup of PC 10′; a logon information management system 507 according to the present invention; an SMI handler 509 for operating CPU 11 in SMM; an INT13H handler 511 for accessing magnetic disk device 39.

NVRAM 49 shown in FIG. 8(B) is a RAM that is backed up by a battery so as not to be erased upon power-off of PC 10′. NVRAM 49 may also be read/write-protected. Read/write-protected NVRAM 49 cannot be subjected to read/write operations from outside. Secure NVRAM 49 stores setting information 513 on device controllers of the PC 10′, and a cache database 515. Setting information 513 mainly includes the order of activating the disk devices, the drive numbers, the method of connecting peripheral devices, and parameters about data transfer. Cache database 515 stores user IDs and their corresponding logon information. Cache database 515 can be accessed only by system BIOS 501, and its stored content cannot be referred to by Windows® or other OSs.

In main memory 21 shown in FIG. 8(C), an area used as a SMRAM 517 is reserved in addition to a user area 519 used in regular operations of PC. When SMI handler 509 is called from system BIOS 501 and CPU 11 enters SMM, CPU 11 operates in single task mode and all interrupts are disabled. Further, SMRAM area 517 is made usable exclusively by CPU 11 operating in SMM. Therefore, while CPU 11 is operating in SMM, no program can run except a single task operating under the control of system BIOS 501, and no processes access SMRAM 517 except the relevant program.

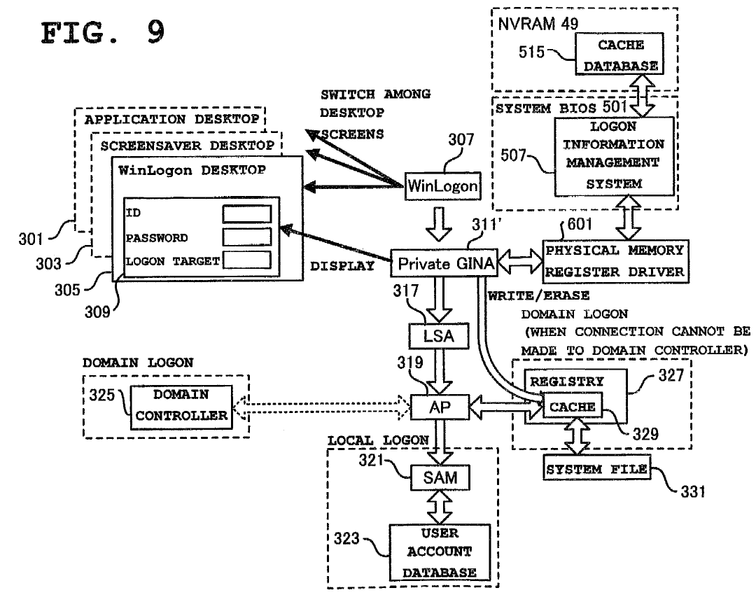

FIG. 9 is a conceptual view showing the mechanism of user logon, in accordance with a second embodiment of the present invention. Upon power-on of PC 10′, system BIOS 501 stored in BIOS flash ROM 47 are first read out to CPU 11 and executed, and a self test and initial configuration of the hardware in PC 10′ are performed. Subsequently, Windows® installed on HDD 39 is read out to CPU 11 and executed. When Windows® is started, the three desktop screens are created, namely, application desktop 301 to be displayed during regular operations in Windows®, screen saver desktop 303 for displaying a screen saver, and WinLogon desktop 305 for displaying a logon screen. WinLogon 307 displays WinLogon desktop 305 among them on display 25.

On WinLogon desktop 305, a private GINA 311′ displays dialog 309 for entering a user ID, a password, and a logon target. Private GINA 311′ is a GINA customized for the present embodiment and registered as a component of Windows®. When a user enters a user ID and a password on dialog 309 through keyboard 55, the entered user ID is passed from private GINA 311′ to logon information management system 507 operating in system BIOS 501 via a physical memory register driver 601. Physical memory register driver 601 is a module for exchanging information between system BIOS 501 and Windows®, and is installed in the system file of Windows® as a kernel-mode driver. Although the system BIOS cannot interpret the logical address of main memory 21 managed by Windows®, physical memory register driver 601 can keep a particular physical address on main memory 21, call SMI handler 509, use an I/O instruction to issue an SMI via the register of CPU 11, and inform system BIOS 501 of the physical address specified by the register of CPU 11.

Logon information management system 507 reads out logon information corresponding to the passed user ID from cache database 515. System BIOS 501 stores the read-out logon information in the informed physical address and terminates the operation of CPU 11 in SMM. Thus, the data can be passed to Windows®. The physical address on main memory 21 as used herein may be either within SMRAM 517 area or within user area 519. Blocks other than those described above are the same as the blocks in the first embodiment illustrated in FIG. 4, therefore denoted by like reference numerals and will not be described.

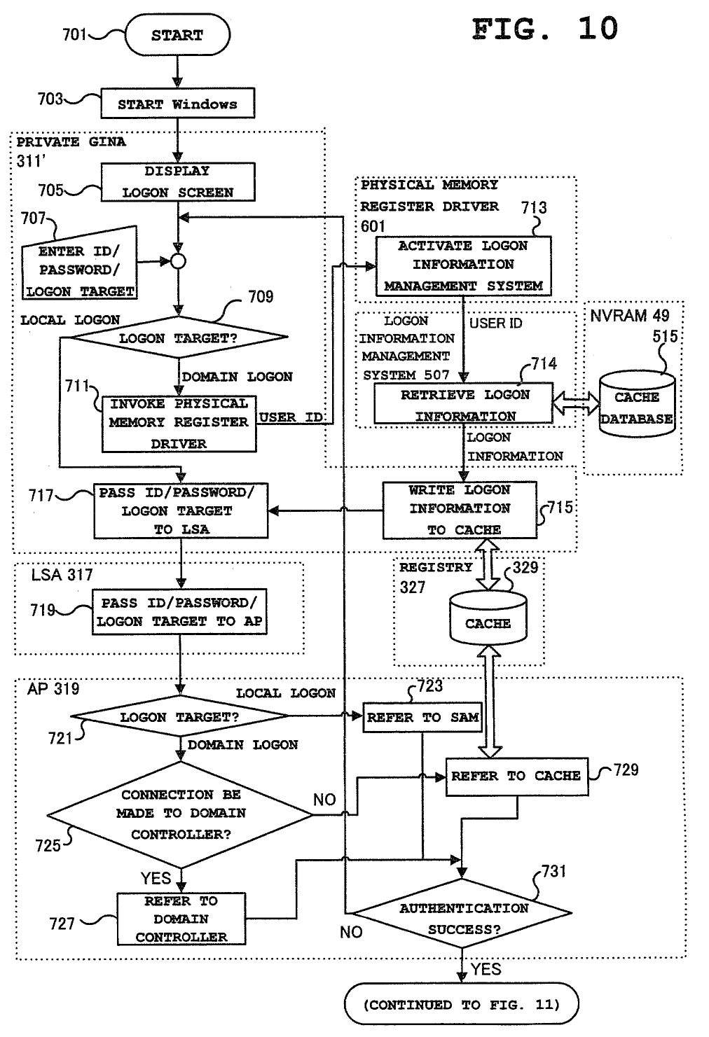

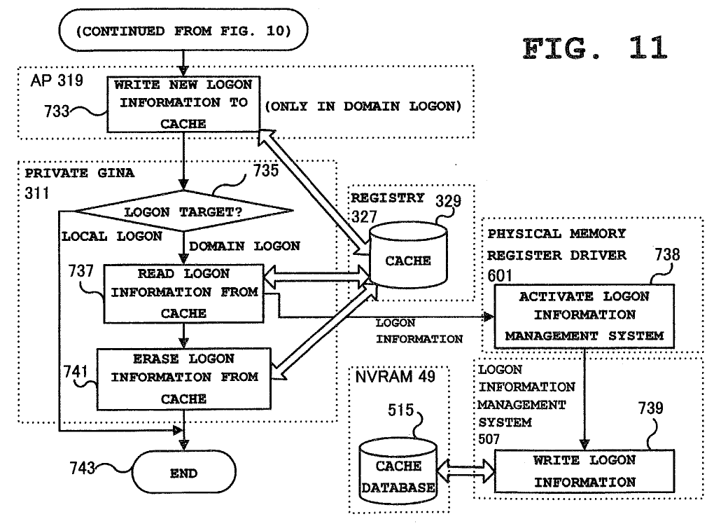

FIGS. 10 and 11 are flowcharts showing a user logon process, in accordance wtih a second embodiment of the present invention. When PC 10′ is powered on (block 701) and Windows® is started (block 703), WinLogon 307 displays WinLogon desktop screen 305 on display 25 and private GINA 311′ displays dialog 309 for entering a user ID, a password, and a logon target on the desktop screen (block 705). When a user enters a user ID, a password, and a logon target on dialog 309 (block 707), private GINA 311′ first checks the logon target (block 709). If the logon is a local logon, the process skips processing in blocks 711-715 and proceeds to block 717.

If the logon is a domain logon in block 709, the user ID entered by the user is passed to physical memory register driver 601 (block 711). CPU 11 enters SMM at this point, and logon information management system 507 operates under the control of system BIOS 501 to receive the user ID (block 713). Logon information management system 507 reads out logon information corresponding to the entered user ID from cache database 515 in NVRAM 49 and writes the logon information to a specified address on main memory 21 (block 713). SMM terminates at this point and the control is returned to Windows®, and private GINA 311′ with the control passed thereto can receive the logon information. If the logon information corresponding to the entered user ID exists in cache database 315, private GINA 311′ that has received the logon information writes the information to cache 329 in registry 327 of the PC (block 715). If the logon information corresponding to the user ID does not exist in the cache database 315, no information is written to cache 329.

After the above processing has been completed, private GINA 311′ calls WlxLoggedOutSAS, which is one of API functions, to pass the user-entered user ID, password, and logon target to LSA 317 (block 717). The user ID, the password, and the logon target received by LSA 317 are further passed to AP 319, where user authentication processing is performed in the same manner as conventional art (block 719). AP 319 checks the logon target (block 721). If the logon is a local logon, AP 319 refers to the user account database 323 of SAM 321 (block 723). If the logon is a domain logon, AP 319 first attempts to connect to domain controller 325 (block 725). If a connection can be made, AP 319 queries the domain controller whether the user-entered password is authenticated (block 727). If a connection cannot be made to the domain controller 325 in the domain logon, cache 329 is referred to (block 729). If the logon information corresponding to the entered user ID exists in cache database 315 in TPM 57, the corresponding logon information has been written to cache 329 in blocks 713 to 715. Therefore, AP 319 can refer to this logon information in cache 329. Thus, the domain logon can be performed with the information in cache 329 even though a connection cannot be made to domain controller 325. If the logon information corresponding to the entered user ID does not exist in block 713, the domain logon is impossible unless a connection can be made to domain controller 325 because no information has been written to cache 329.

If the user authentication succeeds (block 731), AP 319 writes new logon information resulted from the success of the authentication for this domain logon to cache 329 irrespective of success or failure in connecting to domain controller 325 (block 733). The new logon information written at this point includes the user ID and the password by which this domain logon has succeeded, and the date and time of the logon. The past logon information written in block 715 may be overwritten or preserved at this point. For the local logon, the logon information is not written to cache 329.

Private GINA 311′ again checks the logon target (block 735). If the logon is a local logon, the process skips processing in blocks 737-741 and proceeds to block 743. If the logon is a domain logon in block 735, private GINA 311′ reads the new logon information written to cache 329 (block 737), passes the read new logon information to logon information management system 507 via physical memory register driver 601 as in the block 711 (block 738) to record the logon information in cache database 515 in NVRAM 49 (block 739). Private GINA 311′ then erases the past logon information written in block 715 and the new logon information written in block 733 from cache 329 (block 741). Thus, the user authentication is completed (block 743). Private GINA 311′ calls application desktop 301 with WlxActivateUserShell, which is one of API functions, and the user may perform regular work. If the authentication fails in block 731, the process returns to entry in block 707.

As can be seen from the above description, the present embodiment can utilize BIOS flash ROM 47 and NVRAM 49 included in PC 10′ to prevent user operations from accessing cache database 515 and reading the content, without requiring special hardware such as TPM 57. As to software, no modification is required except customizing the GINA for Windows® to make it into private GINA 311′ and installing physical memory register driver 601. Of course, as in the first embodiment, the logon information will never be obtained through cache 329 by users who can log on to the domain as well as a third party other than those users, because the content of cache 329 is erased.

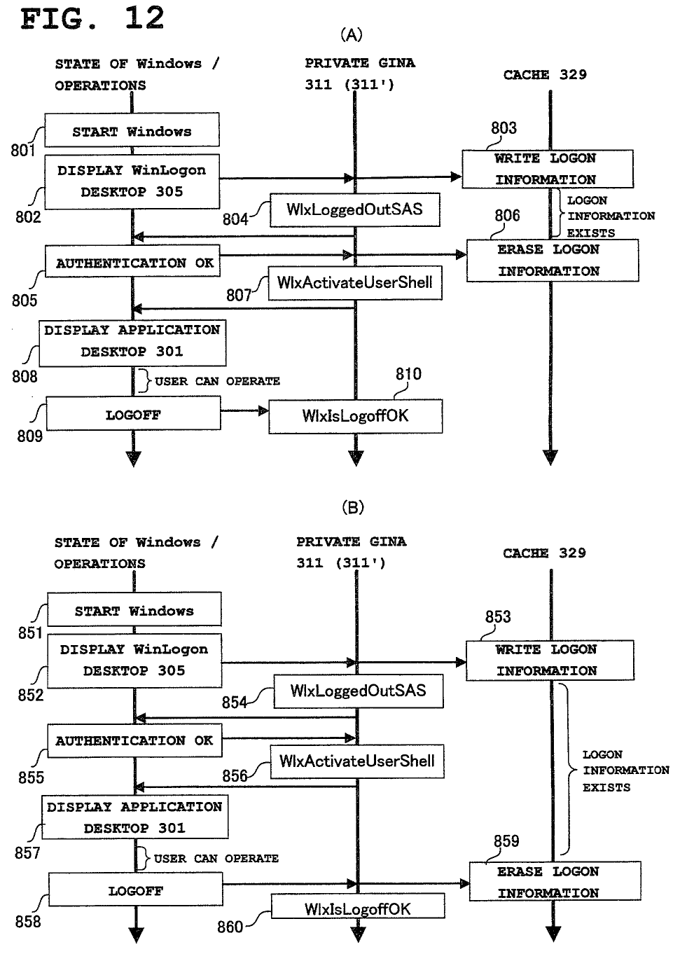

FIG. 12 is a conceptual view showing the timing with which the logon information is written to and erased from registry 327 in the domain logon. In these figures, reference numerals are added to blocks in ascending order along the time-line in which the blocks are implemented. FIG. 12(A) shows the timing in the first and second embodiments. From the left, the state of Windows® and user operations, operations of private GINA 311 or 311′, and the state of cache 329 are shown. Windows® is started (block 801), and WinLogon desktop 305 is displayed on display 25 (block 802). Private GINA 311 or 311′ receives a user ID, a password, and a logon target entered by a user and retrieves the logon information on the user from cache database 315 or 515 to write the logon information to cache 329 (block 803). Private GINA 311 or 311′ then initiates the domain logon by calling the API function WlxLoggedOutSAS (block 804).

When the authentication of the user for the domain logon is completed with the logon information in cache 329 (block 805), private GINA 311 or 311′ erases all logon information from cache 329 (block 806). Private GINA 311 or 311′ then activates application desktop 301 with the API function WlxActivateUserShell (blocks 807 and 808). The user may now work on PC 10 or 10′ using network resources of the domain. The logon information on any user does not remain in cache 329 during the user's working, so that the tolerance for password attacks is enhanced. When the user finishes the work and performs an operation for logoff (block 809), private GINA 311 or 311′ calls the API function WlxIsLogoffOK and performs logoff processing (block 810). When the user powers off PC 10 or 10′ after logging off, the logon information does not exist in the cache 329. Therefore, it is impossible to read the logon information from the system file even if PC 10 or 10′ or the magnetic disk device included therein is stolen.

In the first and second embodiments described in FIG. 12(A), the logon information is erased in block 806 immediately after the user authentication succeeds. Therefore, the logon information only exists in cache 329 during the period between blocks 803 to 806. Although the user currently logging on could read the logon information from cache 329 with the user's operation during the period between blocks 808 and 809, at this point the processing indicated by block 806 has already been completed and all logon information has been erased from cache 329. This means that the user currently logging on would fail if trying to read the logon information from cache 329. There are few situations where the absence of the logon information in cache 329 causes problems in operations of the OS and applications.

However, some applications such as an e-mail client refer to and use the logon information on a user currently logging on written to cache 329. For example, when an application uses the SSPI (Security Support Provider Interface) to perform client-server communication, the application may perform authentication using the logon information recorded in cache 329 for confirming the authenticity of the client and the server and for ensuring the confidentiality and integrity of data to be communicated. In such cases, the applications requiring performing the authentication will not function if the logon information on the user currently logging on is not recorded in cache 329.

A way of solving the above-mentioned problem is to erase the logon information upon user logoff, rather than immediately after the success of user authentication. FIG. 12(B) shows a variation of the first and second embodiments, where the timing of erasing the logon information is changed in such a manner. This variation of the embodiments is exactly the same as the first and second embodiments except that the timing of erasing the logon information is changed. Therefore, the hardware and software configuration and algorithms will not be described. In addition, FIG. 12(B) has the same structure as that of FIG. 12(A). Windows® is started (block 851), and WinLogon desktop 305 is displayed on display 25 (block 852). Private GINA 311 or 311′ receives a user ID, a password, and a logon target entered by a user and retrieves the logon information on the user from cache database 315 or 515 to write the logon information to cache 329 (block 853). Private GINA 311 or 311′ then initiates the domain logon by calling the API function WlxLoggedOutSAS (block 854).

When the authentication of the user for the domain logon is completed with the logon information in cache 329 (block 855), private GINA 311 or 311′ activates application desktop 301 with the API function WlxActivateUserShell (blocks 856 and 857). The user may now perform his work. When the user finishes the work and performs an operation for logoff (block 858), private GINA 311 or 311′ erases all logon information from cache 329 (block 859). Private GINA 311 or 311′ then calls the API function WlxIsLogoffOK and performs logoff processing (block 860). When the user powers off PC 10 or 10′ after logging off, the logon information does not exist in cache 329. Therefore, it is impossible to read the logon information from the system file because the logon information is not saved in the system file.

According to this variation of the embodiments, the logon information is erased in block 859 immediately after the user relevant to the logon information logs off. Therefore, the logon information only exists in the cache 329 during the period between blocks 853 and 859. On the other hand, since the user currently logging on can read information from the cache 329 with the user's operation during the period between blocks 857 and 858, the user can read the logon information with the user's operation. However, the logon information written to the cache 329 in block 853 is only that on the user currently logging on. The logon information on other users exists only in the cache database 315 or 515 that cannot be accessed with the user's operation, and is not written to cache 329. That is, the information that can be read by the user currently logging on from cache 329 is the known user ID and password of the user's own, and the user cannot obtain the logon information on other users. Of course, the logon information on the user currently logging on will never be obtained through cache 329 by other users who can log on to the domain, as well as a third party other than those users. Still, since the logon information on the user currently logging on exists in cache 329, it is not the case that applications requiring performing authentication with the SSPI do not function.

In the prior art, the logon information is saved in a cache as many times as is set in the range of 0 to 50 times for the past successful domain logons. This is defined as a specification of Windows®, and therefore the saving of the logon information cannot be set according to other conditions. However, the present invention do not require saving the logon information according to the specification of Windows®, so that the condition for saving the logon information may be arbitrarily set. For example, the number of times of saving may be set to any number above 50 for the past successful domain logons, as long as the storage capacity of TPM 57 or NVRAM 49 permits. Conditions other than the number of times of saving may also be set. For example, a condition for saving the logon information may be set in terms of the date and time, such as “successful domain logons in the past month.” A combination of conditions may also be set. Of course, changing the saving conditions will not compromise security because all logon information is saved in TPM 57 or NVRAM 49 that cannot be read by the user with the user's operation.

As has been described, the present invention provides a method and apparatus for enhancing security of domain authentication without modifying basic modules of Windows®.

It is also important to note that although the present invention has been described in the context of a fully functional computer system, those skilled in the art will appreciate that the mechanisms of the present invention are capable of being distributed as a program product in a variety of forms, and that the present invention applies equally regardless of the particular type of signal bearing media utilized to actually carry out the distribution. Examples of signal bearing media include, without limitation, recordable type media such as floppy disks or compact discs and transmission type media such as analog or digital communications links.

While the invention has been particularly shown and described with reference to a preferred embodiment, it will be understood by those skilled in the art that various changes in form and detail may be made therein without departing from the spirit and scope of the invention.

What is claimed is:

1. A method for performing a domain logon by a user via a client computer within a network environment, wherein said client computer uses Windows® as an operating system, said method comprising:
providing a secure storage area containing user identification information and domain password information corresponding to user identification information;
in response to a reciept of a user-entered user identification and a user-entered domain password by a first module of a Windows® operating system, writing domain password information stored in said secure storage area and corresponding to said user identification to a registry of said Windows® operating system;
performing authentication for domain logon by a second module of said Windows® operating system based on said received domain password and said domain password information written to said registry of said Windows® operating system; and
removing said domain password information by said first module of said Windows® operating system from said registry of said Windows® operating system after said authentication.

2. The method of claim 1, wherein said secure storage area is provided in said network environment or in said client computer.

3. The method of claim 1, wherein said secure storage area is provided in a Trusted Platform Module within said client computer.

4. The method of claim 1, wherein said secure storage area is provided in a non-volatile memory accessible only by a BIOS of said client computer.

5. The method of claim 1, wherein said removing further includes writing domain password information generated from said user-entered domain password to said secure storage area.

6. The method of claim 1, wherein said removing is performed upon a completion of said authentication or upon logoff of said user.

7. The method of claim 1, wherein said first module is a Graphical Identification and Authentication (GINA) and said second module is an Authentication Package (AP).

8. A method for performing a domain logon by a user via a client computer within a network environment having a domain controller, wherein said client computer uses Windows® as an operating system, said method comprising:
providing said network environment with a secure storage area containing user identification information and domain password information corresponding to said user identification information;
in response to a receipt of a user-entered user identification information and a user-entered domain password by a first module of said Windows® operating system, writing domain password information stored in said secure storage area and said corresponding user identification information to a registry of said Windows® operating system;
attempting to connect to said domain controller by a second module of said Windows® operating system;
performing authentication for a domain logon by querying said domain controller for said user identification information and said domain password if a connection to said domain controller by said second module of said Windows® operating system succeeds, and performing authentication for said domain logon based on said received domain password and said domain password information written to said registry if a connection to said domain controller by said second module said Windows® operating system fails; and
removing said domain password information by said first module of said Windows® operating system from said registry after said authentication.

9. The method of claim 8, wherein said removing is performed upon a completion of said authentication or upon logoff of said user.

10. The method of claim 8, wherein said first module is a Graphical Identification and Authentication (GINA) and said second module is an Authentication Package (AP).

11. A computer usable medium having a computer program product for performing a domain logon by a user via a client computer within a network environment, wherein said client computer uses Windows® as an operating system, said computer usable medium comprising:
program code means for providing a secure storage area containing user identification information and domain password information corresponding to user identification information;
program code means for, in response to a reciept of a user-entered user identification and a user-entered domain password by a first module of a Windows® operating system, writing domain password information stored in said secure storage area and corresponding to said user identification to a registry of said Windows® operating system;
program code means for performing authentication for domain logon by a second module of said Windows® operating system based on said received domain password and said domain password information written to said registry of said Windows® operating system; and
program code means for removing said domain password information by said first module of said Windows® operating system from said registry of said Windows® operating system after said authentication.

12. The computer usable medium of claim 11, wherein said secure storage area is provided in said network environment or in said client computer.

13. The computer usable medium of claim 11, wherein said secure storage area is provided in a Trusted Platform Module within said client computer.

14. The computer usable medium of claim 11, wherein said secure storage area is provided in a non-volatile memory accessible only by a BIOS of said client computer.

15. The computer usable medium of claim 11, wherein said program code means for premoving further includes program code means for pwriting domain password information generated from said user-entered domain password to said secure storage area.

16. The computer usable medium of claim 11, wherein said program code means for premoving is executed upon a completion of said authentication or upon logoff of said user.

17. The computer usable medium of claim 1, wherein said first module is a Graphical Identification and Authentication (GINA) and said second module is an Authentication Package (AP).

18. A computer usable medium for performing a domain logon by a user via a client computer within a network environment having a domain controller, wherein said client computer uses Windows® as an operating system, said computer usable medium comprising:
program code means for providing said network environment with a secure storage area containing user identification information and domain password information corresponding to said user identification information;
program code means for, in response to a receipt of a user-entered user identification information and a user-entered domain password by a first module of said Windows® operating system, writing domain password information stored in said secure storage area and said corresponding user identification information to a registry of said Windows® operating system;
program code means for attempting to connect to said domain controller by a second module of said Windows® operating system;
program code means for performing authentication for a domain logon by querying said domain controller for said user identification information and said domain password if a connection to said domain controller by said second module of said Windows® operating system succeeds, and for performing authentication for said domain logon based on said received domain password and said domain password information written to said registry if a connection to said domain controller by said second module said Windows® operating system fails; and
program code means for removing said domain password information by said first module of said Windows® operating system from said registry after said authentication.

19. The computer usable medium of claim 18, wherein said program code means for removing is executed upon a completion of said authentication or upon logoff of said user.

20. The computer usable medium of claim 18, wherein said first module is a Graphical Identification and Authentication (GINA) and said second module is an Authentication Package (AP).
